(19) United States
(12) Patent Application Publication
(10) Pub. No.: US 2024/0017411 A1
(43) Pub. Date: Jan. 18, 2024

(54) Method for Controlling Displacement of a Robot

(71) Applicant: ABB Schweiz AG, Baden (CH)

(72) Inventors: Arne Wahrburg, Weiterstadt (DE); Nima Enayati, Mannheim (DE); Debora Clever, Zwingenberg (DE); Mikael Norrlöf, Norrköping (SE); Mattias Björkman, Västerås (SE); Giacomo Spampinato, Västerås (SE); Jonas Haulin, Shanghai (CN)

(73) Assignee: ABB Schweiz AG, Baden (CH)

(21) Appl. No.: 18/475,574

(22) Filed: Sep. 27, 2023

Related U.S. Application Data
(63) Continuation of application No. PCT/EP2021/058259, filed on Mar. 30, 2021.

(51) Int. Cl. B25J 9/16; B25J 13/08

(52) U.S. Cl. CPC B25J 9/1664; B25J 13/089; B25J 9/1653

(57) ABSTRACT

A method for controlling displacement of a robot from an initial pose to a target pose includes providing a movement command, which specifies at least the target pose and an nominal path to be followed from the initial pose to the target pose; associating with the command an allowed deviation from the nominal path; identifying a real path that deviates from the nominal path by no more than the allowed deviation; and controlling the robot to move along said real path.

### CROSS-REFERENCE TO RELATED APPLICATIONS

The instant application claims priority to International Patent Application No. PCT/EP2021/058259, filed Mar. 30, 2021, which is incorporated herein in its entirety by reference.

### FIELD OF THE DISCLOSURE

The present disclosure generally relates to a method for controlling displacement from an initial pose to a target pose of a robot that is displaceable in a plurality of coordinates.

### BACKGROUND OF THE INVENTION

Every robot has an inherent coordinate system, in which each coordinate is associated to a specific actuator, and isolated operation of that actuator will modify only the coordinate associated to it. In articulated robots, these inherent coordinates are angular coordinates, and a position in Cartesian space the robot will assume when the actuators are set to the coordinates specified by a given inherent coordinate vector can be calculated quite straightforwardly when dimensions of the robot's links are known. Finding out an inherent coordinate vector associated to a desired position in Cartesian space is a more complicated problem, which, depending on the design of the robot and the position chosen, may have a single solution, several ones, or none at all. Things get still more complicated if not only the position of a reference point of the robot, e.g., a tool center point, in Cartesian space, is considered, but also the spatial orientation of a tool or other object attached to said reference point. In general, it is therefore impractical for a human user to control displacement of a robot by specifying a target pose directly in the robot's inherent coordinate system. Instead, the user will specify a target pose in some more convenient coordinate system, and the task of finding an inherent coordinate vector which will yield this pose, and of setting the actuators of the robot to their respective coordinate values specified by the inherent coordinate vector is left to a dedicated controller.

The controller receives the information needed for its task by means of program instructions which will specify at least a target pose and an nominal path by which the robot is meant to reach the target pose. A program instruction will not necessarily specify a start pose, since the start pose of the robot at the beginning of execution of a movement instruction can either be directly detected or can be assumed to be the target pose of the most recently executed movement instruction. Since there is an infinite variety of paths by which the robot might move from start pose to target pose, the instruction specifies the type of path to be followed, e.g., a path where the reference point of the robot moves along a straight line, or a path which results from all inherent coordinates of the robot shifting at a constant rate set so that all inherent coordinates reach their respective target value at the same time.

Such a path will be referred to as a nominal path in the present disclosure because it is in fact just a geometrical concept. In practice, imperfections of control will cause the robot to follow a path that deviates to a certain extent from the nominal path. On the one hand, such deviations must be strictly limited in order to ensure that a deviation from the nominal path will not cause the robot to collide with an object located adjacent to the nominal path. On the other hand, the stricter the pose of the robot is controlled, be it in the course of its displacement or at the target pose itself, the slower will be its displacement and, hence, its productivity. Further, even if it has been checked once that a planned path for the robot is safe to follow because the distance from foreign objects is large enough, such a check will have to be repeated whenever one of the foreign objects in the vicinity of the robot is displaced. Ensuring safe operation of a robot in an environment in which objects may move in a manner not coordinated with the movement of the robot is therefore a difficult and time-consuming task.

### BRIEF SUMMARY OF THE INVENTION

The present disclosure describes a method for controlling displacement of a robot, which enables time-efficient operation while satisfying safety requirements and/or other constraints.

According to a first aspect of the disclosure, a method for controlling displacement from an initial pose to a target pose of a robot which is displaceable in a plurality of coordinates, comprising the steps of: a) providing a movement command that specifies at least the target pose and an nominal path to be followed from the initial pose to the target pose, b) associating to the command an allowed deviation from the nominal path, c) identifying a real path which deviates from the nominal path by not more than the allowed deviation and d) controlling the robot to move along said real path, is described.

According to a second aspect of the disclosure, a method for controlling displacement of a robot in a plurality of coordinates from an initial pose to a target pose is described, which method includes the steps of: a) providing a movement command that specifies at least an nominal target pose, b) associating to the command an allowed deviation from the nominal target pose, and c) identifying a real target pose, which deviates from the nominal target pose by not more than the allowed deviation, and d) controlling the robot to move to said real target pose.

Between steps c) and d), a step of displaying the identified real path and/or of the identified real pose to a user on a display may be provided, so as to allow the user to judge appropriateness of the planned real path and/or pose, and to approve or discard it.

With the allowed deviation defined, there is no need for the controller to guide the robot as closely along the nominal path or as closely to the target pose as possible. Since unnecessary movements of the robot can be avoided, the target pose can be reached more easily, faster and/or with less expense of energy. Since not any deviation from the nominal path must be suppressed but only those that would exceed the allowed threshold, longer reaction times of the controller can be allowed, and since corrective forces can be applied for a longer time, their size can be reduced, allowing for smoother and more energy-efficient displacement.

The step of associating can be carried out by specifying the allowed deviation in the movement command of step a) itself, or by some other input channel, such as a setting command transmitted to the controller before the movement command is due to be executed.

In principle, whenever the controller is input a movement command in step a), it might determine anew and in real time an associated real path and then control the robot to move along it. In practice, however, whenever a movement command is input to the controller in step a), the command is usually part of a program which has been established earlier in an offline or motion planning mode, so that between the time the program is established and the time it is executed, there is time to identify the real path, and to calculate and store control information which, when retrieved and supplied to the robot by the controller, will cause the robot to move along the real path as planned. Further, since the program is usually carried out repeatedly, it is possible to observe the real path resulting from stored control information, to compare it to the nominal path, and to optimize the stored control information so that discrepancies between the real path and the nominal one are minimized. With a deviation allowed, it is obvious that there will be no single possible real path associated to the nominal path, but an infinite variety of these. Among these varieties, the one best suiting specific requirements may be determined by minimizing a cost function.

Similar to the allowed deviation, the cost function to be minimized may be specified by the movement command itself, of by a setting command which should preferably precede the movement command.

The cost function may take account of any parameter found expedient by the system designer. Typically, the cost function might be designed to increase along with one or more of the following parameters: execution time of the movement command, total energy required to execute the movement command, peak power required to execute the movement command, load imposed on each one of actuators of the robot when executing the command, closeness of a joint speed of the robot to a resonant speed.

Gearboxes typically used in the arms of small robots are strain wave gears. While these have a number of positive properties, one downside is that they suffer from small transmission errors. These transmission errors in duce torque ripple effects that vary with the speed of motion. Once the speed of one of the joints results in the torque ripple frequency coinciding with a mechanical vibration frequency of the arm, the ripple can be amplified. By penalizing operation of the robot at such joint speeds by a high value of the cost function, times in which vibrations of the robot arm can be excited are minimized, and precision of the robot operation is improved.

When minimization of the cost function is carried out in the motion planning mode, it may be appropriate to display values of one or more cost functions associated to the nominal path or pose to a user, and to the identified real path or pose, so that the user can judge the advantage provided by the identified real path or pose over the nominal one. Further, the user can be allowed to define the cost function that is to be used. In the most general case, this might be done by allowing the user to input the function in the form of computer-executable code or a mathematic formula to be parsed and automatically converted into executable code, in practice, it will more frequently be done by allowing the user to choose between a plurality of predefined functions, or, if the cost function is a weighted sum of terms dependent on different parameters, by having the user input weighting parameters associated to each of these terms. In this case, it may be useful to display to the user the value of the cost function thus defined, and/or the path or pose associated to said value, so that the cost value or the path displayed doesn't meet the user's expectations, he may re-define the cost function.

In the event that the predetermined cost function is dependent on a plurality of parameters, of which at least one varies with time, the result of cost function minimization is likely to also vary depending on the time-variable parameter. Consider, for example, the case where the cost function is a weighted sum of cycle time and power consumption, and the weighting coefficient of power consumption is variable reflecting cost of power that is dependent on the time of day, on the availability of wind power, or the like. Here, when power is cheap or availability is good, the result of minimization can be expected to be a path which is quick to move along, but which is not necessarily energy-efficient. The higher the cost of operating power for the robot is, or the less power is available, the more likely it is that the result of minimization is a path that takes long to move along, but where power consumption is low. This can be considered by carrying out the minimization in real time, based on the value of the time-variable parameter at the very instant of carrying out the minimization. Doing this will require huge processing power. If the time-varying parameter can take only a plurality of discrete values, it is possible to save processing power by carrying out the minimization for a given movement command in advance for any value the time-varying parameter may take, store the real paths thus found, and, when the movement command actually has to be executed, retrieving from storage the real path that is associated to the current value of the time-variable parameter,

If an object in the vicinity of the robot moves, it may block the nominal path, the nominal target pose, or part of the allowed deviation range around these. In such a case, above step c) may be repeated taking account of the changed position of the object, in order to find a new path to the target pose that can be used without a disk of collision with the moved object. Since such a new path is still within the deviation range, there is no risk of conflict with other objects; therefore, a switchover to the new path is inherently safe and can be carried out autonomously without intervention by the user.

If positions of objects in the vicinity of the robot are monitored, it is possible to judge how close the robot will come to any of these when following the nominal path, and based thereon, a safe deviation can be determined by which the robot may deviate from the nominal path without risking a collision. By setting said safe deviation as the allowed deviation in the movement command, operation of the robot can be adapted to objects moving in the vicinity of the robot. Adjustment of the allowed deviation can be done whenever, during operation of the robot, movement of an object is detected.

### BRIEF DESCRIPTION OF THE SEVERAL VIEWS OF THE DRAWING(S)

FIG. 1 is a schematic diagram of a robot system in accordance with the disclosure.

FIG. 2 is a schematic representation of a job to be executed by the robot system of FIG. 1.

FIG. 3 is a flowchart for a method in accordance with the disclosure.

### DETAILED DESCRIPTION OF THE INVENTION

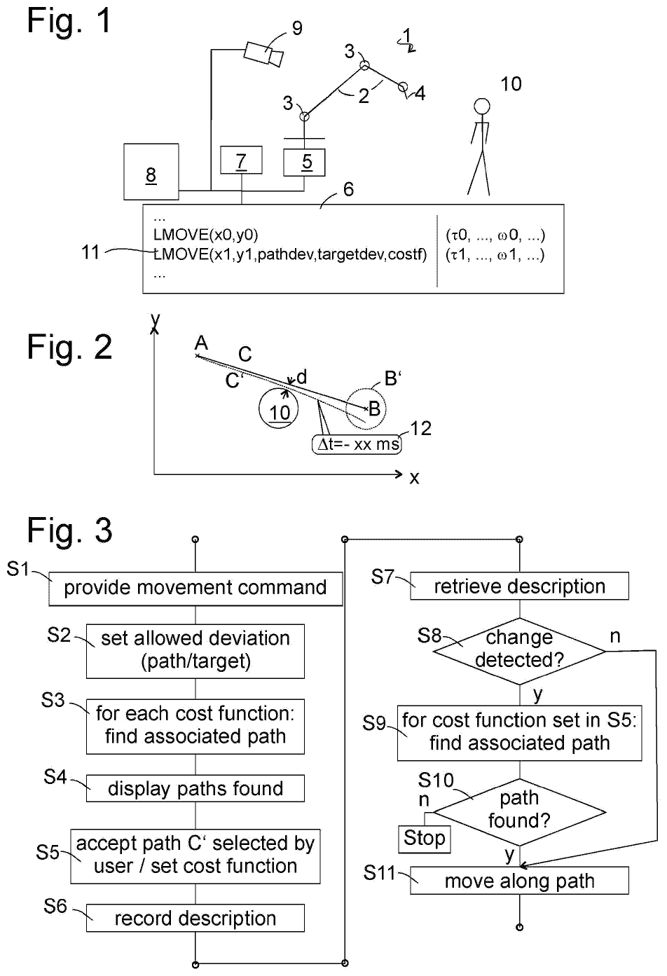

FIG. 1 is a schematic representation of a robot system. The robot system comprises an articulated robot 1 of conventional design, comprising a plurality of links 2, joints 3 by which the links 2 are rotatably connected to each other, and actuators, not shown, for driving rotation of the links 2. A reference point 4 at a distal end of the articulated robot 1 may be a gripper for seizing and manipulating a workpiece, a tool operated by the robot, or the like.

A controller 5 is operatively connected to the articulated robot 1 and to a memory 6 and is adapted to control displacement of the robot 1 based on control information stored in memory 6.

One form in which the control information is stored is a program, i.e., a series of instructions to be executed successively by the robot and specifying where the robot is to move and, possibly, what function the robot is to execute at its destination. Another form is actuator control data such as a target speed or torque for each actuator of the robot, and which must be supplied to the actuators with appropriate timing to produce a desired movement. A processor for translating program instructions into actuator control data is denoted 7.

A workstation or personal computer 8 is provided for writing thereon commands of the program (step S1 of FIG. 3). Software on the workstation 8 comprises a kinematic model of the robot, enabling the workstation to predict the movement by which the robot will react to a specific movement command or actuator control information. Further, the workstation 8 stores a model of the vicinity of the robot and of objects in it. A camera 9 or one or more other appropriate sensor(s) may be provided for monitoring the vicinity of the robot 1 and updating the model if changes in the vicinity of the robot are detected.

FIG. 2 illustrates a model of the vicinity of the robot 1. Movement of the robot 1 can be regarded as taking place in a hyperspace, the number of dimensions of which is the number of actuators or the number of degrees of freedom of the robot 1. For the sake of simplicity, only two dimensions x and y are shown in FIG. 2. The robot 1 is located at a point A=(xo, yO), and its program comprises a command 11 instructing it to move to a point B=(x1, y1). The command might, for instance, be a linear displacement command (LMOVE), instructing the robot to move to B along a straight line in Cartesian space. For the sake of simplicity, it is assumed that the coordinates (x, y) are Cartesian, and that the movement from A to B will be along a straight line in FIG. 2. This straight-line C passes near an object 10, which object 10 the robot 1 must not hit. It is readily apparent from the diagram of FIG. 2 that this will not happen if the robot truly follows the straight-line C. In order to move along the straight line, various actuators of the robot must operate with precisely controlled speed and timing. The more strictly the straight line must be followed, the longer the movement is likely to take.

When the program for the robot 1 is being written, the above movement from A to B is encoded by an instruction 11, which specifies not only a straight movement and target coordinates (x1, y1) of the movement, but also an acceptable deviation (pathdev) of the true path of the robot 1 from the prescribed straight-line C. Such a deviation may be specified manually by a user who is developing the program on the workstation 8, after having been shown the diagram of FIG. 2 on a display of the work station 8 and having judged or measured the distance d between the line C and the object 10 shown; and/or the deviation might be calculated by the workstation based on the known coordinates of line C and object 10 and entered as a parameter into the movement command automatically or, possibly after having been proposed to the user and approved or, possibly amended by the user (step S2). The deviation can thus be thought of as defining the width of a space extending along and around line C, in which the robot is safe from collision, regardless of where in this space it is located.

A deviation may be allowable not only in the course of a movement from A to B, but also at the end thereof. If, for example, the purpose of the robot moving to B is to place an object on a surface or drop it into an opening, this purpose can be met when the robot moves precisely to B, but also when it moves to some point nearby on the same surface or above the same opening. A region B′ around point B in FIG. 2 stands for a region where, instead of point B precisely, the movement of the robot 1 might be allowed to end. Such a situation is reflected by the movement command 11 specifying, not only a single target pose such as coordinates (x1, y1), but also an allowed deviation (targetdev) of the finally reached pose from the target pose.

Processor 7 converts the movement command into actuator control information taking account of the allowed path and/or target pose deviations. To this effect, the processor 7 determines a real path to be followed by the robot, i.e., a path that differs from the nominal path specified in the command, but by no more than the allowed deviation, by finding a path which minimizes a given cost function (step S3). Techniques for finding such a path by minimizing a predetermined cost function are known in the art and are therefore not described in detail here. Processor 7 may include a plurality of predefined cost functions, one for evaluating the time required by robot 1 for executing the movement defined in a program command, and others for evaluating the amount of energy required for the movement, and/or peak loads. The results of minimizing each one of these cost functions are displayed to the user (S4), for example, by displaying in the diagram of FIG. 2 shown to the user a suggested real path C′, and, possibly, the cost saving that would be achieved by adopting the suggested path. In the example of FIG. 2, path C′ is the result of minimizing execution time, and is depicted accompanied by a label 12 indicating the amount of time that would be saved by adopting path C′ instead of path C. Paths obtained by minimizing the other cost functions and their associated cost savings can be shown in the same diagram, and the user can be allowed to select one of these (S5), e.g., by clicking on the associated label, whereupon the selected cost function is recorded in command 11 as a further argument (costf).

One of the cost functions evaluated by processor 7 can be a linear combination of the others. Weighting coefficients of this linear combination can be input by the user. A path found by minimizing this cost function will be a compromise between the competing requirements of reducing execution time, energy, and load.

When the user accepts a suggested real path C′, associated to command 11, processor 7 records a description thereof in memory 6 (S6), and a next program command is processed in the same way. The description can be in the form of coordinates of the real path, or of actuator control information (t, w) which, when supplied to the actuators of the robot 1, will cause it to move along the path C′.

When the entire program has been processed in this way, the robot 1 is ready to execute the program. To this effect, controller 5 retrieves the real path description from memory 6 (S7) and uses it for controlling the actuators of the robot 1 (S11).

According to an advanced variant of the method, step S3 is carried out not for a single cost function, but for two or more cost functions, and for each of these, a real path C′ determined for it in step S3 is stored. In that way, when the command to move from A to B is actually input into controller 5 to be executed, controller 5 retrieves from memory 6 the real path C′ or its control information that is associated to the currently valid cost function.

The currently valid cost function can be set arbitrarily by specifying the valid const function in the movement command or in a command that is sent to controller 5 before the movement command. Alternatively, or additionally, the currently valid cost function may be determined by a timer or some other input to the controller 5. In a preferred embodiment, the cost function is a weighted sum of at least a first term representative of the time required to carry out the specified movement, and a second term representative of the power consumed for execution of the movement. This latter term is weighted by a weighting coefficient representative of the cost of electric power: this coefficient can take a limited number of predetermined values, for example the cost of power may be high when demand is high in the daytime, and low at night. Minimization of the cost function will then yield different results according to the cost of power, and the real path C′ by which the robot moves while the cost of power is high will be slower, but more energy-efficient than the real path C′ adopted while power is inexpensive.

The program can be executed in this way as long as the positions of the objects in the vicinity of the robot remains unchanged. In practice, and in particular in collaborative applications, some of the objects may be mobile, or new objects may enter the vicinity of the robot while the program is being executed. Camera 9 is provided in order to detect when that happens.

When a change is detected in the vicinity of the robot in step S8, the camera 9 may detect object 10 approaching path C of the robot 1 in such a way that, while the robot is moving somewhere within its allowed deviation range off path C, a collision with object 10 would be possible. In that case, safety of the real path C′ determined earlier is no longer guaranteed. Controller 5 calls processor 7 to solve once more the cost function minimization problem (S9), this time additionally considering the constraints imposed by the detected movement of object 10. If a new path is found that solves the minimization problem (S10), then the robot is controlled to move from A to B along this path (S11), safely avoiding object 10, an also safe from all other objects in its vicinity, since the new path is still within the allowed deviation range of nominal path C. Thus, due to the allowed deviation being specified in the movement command, the system is capable of adapting autonomously to a change in its environment, and the movement of object 10 does not necessarily interrupt the operation of the robot 1.

The allowed deviation can also be adapted in real time when a change is detected. For example, if the object 10 had been the reason for setting the deviation in step S2, a larger deviation might be allowed if the object 10 is detected to move away from path C. If step S9 is then executed taking account of the larger deviation, there is a chance of finding a new path, which is more efficient than the previous one.

### REFERENCE NUMERALS

1 robot
2 link
3 joint
4 reference point
5 controller 6 memory
7 processor
8 workstation
9 camera
10 object
11 command
12 label

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for controlling displacement from an initial pose to a target pose of a robot that is displaceable in a plurality of coordinates, comprising:
providing a movement command, which specifies at least the target pose and a nominal path to be followed from the initial pose to the target pose;
associating to the movement command an allowed deviation from the nominal path;
identifying a real path, wherein the real path deviates from the nominal path by no more than the allowed deviation; and
controlling the robot to move along the real path.

2. The method of claim 1, wherein the real path is determined, and control information associated to the real path is stored in a memory before the robot has reached the initial pose, and wherein the stored information is retrieved from the memory to carry out control the robot to move along the real path.

3. The method of claim 1, wherein the real path is determined by minimizing a predetermined cost function.

4. A method for controlling displacement of a robot in a plurality of coordinates from an initial pose to a target pose, comprising:
providing a movement command, the movement command specifying at least a nominal target pose;
associating to the movement command an allowed deviation from the nominal target pose;
identifying a real target pose that deviates from the nominal target pose by no more than the allowed deviation; and
controlling the robot to move to the real target pose.

5. The method of claim 4, wherein the real target pose is determined, wherein control information associated to the real target pose is stored in a memory before the robot has reached the initial pose, and wherein the control information is retrieved from the memory and used to control the robot to move to the real target pose.

6. The method of claim 4, wherein the real target pose is determined by minimizing a predetermined cost function.

7. The method of claim 4, wherein the movement command or a setting command preceding the movement command specifies the cost function.

8. The method of claim 4, wherein the cost function is configured to increase along with one or more of the following parameters:
execution time of the movement command,
total energy required to execute the movement command,
peak power required to execute the movement command,
load imposed on each one of actuators of the robot when executing the command, and
closeness of a joint speed of the robot to a resonant speed.

9. The method of claim 4, wherein a value derived from at least one cost function is displayed to a user.

10. The method of claim 4, wherein the cost function is defined by a user.

11. The method of claim 4, wherein the predetermined cost function depends on a plurality of parameters, wherein at least one of the plurality of parameters varies with time.

12. The method of claim 4, wherein the predetermined cost function is one from a plurality of cost functions associated to different sets of values of a plurality of parameters, and wherein the one function is selected based on a current set of values of said parameters.

13. The method of claim 1, further comprising monitoring a vicinity of the robot for a change of position of an object, wherein identifying a real target pose that deviates from the nominal target pose by no more than the allowed deviation is repeated when a change has been observed.

14. The method of claim 1, further comprising monitoring a vicinity of the robot for a presence of objects in the vicinity, deciding a safe deviation based on said monitoring, and setting a safe deviation as the allowed deviation in the movement command based on the safe deviation.

15. The method of claim 4, further comprising monitoring a vicinity of the robot for a change of position of an object, wherein identifying a real target pose that deviates from the nominal target pose by no more than the allowed deviation is repeated when a change has been observed.

16. The method of claim 4, further comprising monitoring a vicinity of the robot for a presence of objects in the vicinity, deciding a safe deviation based on said monitoring, and setting a safe deviation as the allowed deviation in the movement command based on the safe deviation.
